(19) United States
(12) Patent Application Publication
(10) Pub. No.: US 2017/0130060 A1
(43) Pub. Date: May 11, 2017

(54) POWDER COATING COMPOSITIONS FOR REDUCING FRICTION AND WEAR IN HIGH TEMPERATURE HIGH PRESSURE APPLICATIONS

(71) Applicant: Vetco Gray Inc., Houston, TX (US)

(72) Inventors: Sitaraman Krishnan, Potsdam, NY (US); Janice Losenge Lebga-Nebane, Edmonton (CA); Malavarayan Sankarasubramanian, Potsdam, NY (US); Gregory S. Chojecki, Columbus, OH (US); Don H. Rasmussen, Canton, NY (US); John C. Moosbrugger, Potsdam, NY (US)

(73) Assignee: Vetco Gray Inc., Houston, TX (US)

(21) Appl. No.: 15/347,416

(22) Filed: Nov. 9, 2016

Related U.S. Application Data
(60) Provisional application No. 62/252,694, filed on Nov. 9, 2015.

(51) Int. Cl. C09D 5/03; C09C 1/00; C09C 1/30; C10M 125/22; C09D 5/08; C10M 145/20; C10M 125/08; C10M 125/26; C23C 4/12; C09D 171/00

(52) U.S. Cl. CPC C09D 5/032; C23C 4/12; C09C 1/0081; C09C 1/00; C09C 1/30; C09C 1/0003; C09D 171/00; C09D 5/038; C09D 5/08; C10M 145/20; C10M 125/08; C10M 125/26; C10M 125/22; C10M 2201/061; C10M 2201/087; C10M 2201/084; C10M 2209/101; C10N 2220/082; C10N 2220/084; C10N 2230/06; C10N 2230/08

(57) ABSTRACT

The invention provides a powder coating composition comprising of thermoplastic polymers, ceramic particles, and cermet particles for lowering the friction coefficient, and improving wear and corrosion resistance of coated surfaces in high-temperature, high-pressure, and corrosive environments. It also provides a method of coating application for improving adhesion of the coating to the substrate. The coating compositions are devoid of volatile organic solvents and can be applied on surfaces using thermal spraying, compression molding and other particle sintering approaches. A multilayer architecture consisting of an adhesive bottom layer and a non-adhesive, low friction top layer is disclosed. The coating can be used in oil and gas production and seawater injection.

This disclosure claims the benefit of priority to U.S. provisional application No. 62/252,694, filed on Nov. 9, 2015, the content of which is hereby incorporated by reference in its entirety.

### FIELD OF THE INVENTION

The present invention relates to powder coating compositions that can be used as friction and wear resistant coatings for surfaces that are exposed to high temperatures and pressures.

### BACKGROUND OF THE INVENTION

The surfaces of the conventional metallic gate valves used in the oil and gas industry exhibit high coefficients of friction and are susceptible to wear. Coatings have been used to overcome the wear of surfaces due to abrasion, friction, erosion, or corrosion, as they function as a protective barrier between surfaces and their abrasive or corrosive environments. Although the conventional hardfaced coatings may be able to withstand high pressures and temperatures, they are still susceptible to friction, corrosion, and wear.

Load bearing surfaces, such as those found in gate valves used in oil and gas production and in seawater injection are often coated with materials such as tungsten carbide to improve hardness. The valves operate in temperature ranges of typically-30° C. to +175° C. The average bearing pressure between the gate and seat is typically between 20,000 and 30,000 psi. These surfaces exhibit high levels of friction. A manual injection of grease at frequent intervals is necessary to provide the desired lubrication. For example, hydrocarbon-based and silicone-based grease are generally used to provide lubrication during the opening and closing operations. However, lubricant viscosity decreases significantly at higher temperatures, leading to lubrication failure and wear of the sliding surfaces. Thermal degradation and volatilization of the components of grease are also problematic.

In addition, conventional coating materials for reducing the friction of load bearing surfaces can be problematic in certain environments. For example, the relatively high concentrations of dissolved chlorides and other salts present in seawater make corrosion a major problem with metals and certain ceramics. Nickel-based alloys provide improved corrosion resistance over steel, but even highly alloyed nickel-based alloys, with high molybdenum contents, are susceptible to crevice corrosion. Corrosion is a significant issue in metal matrix composites, wherein metal is the predominant component in the metal-ceramic composite coating. In fact, it has been reported that material failures in the offshore industry are often mainly due to corrosion rather than wear. For example, piston rods coated with both hard chromium and ceramic coatings were found to show corrosion failures within three years of service in seawater environments.

Diamond-like carbon coatings can withstand high pressures and temperatures, and exhibit good tribological properties. However, the process used for making these coatings, a process known as chemical vapor deposition (CVD), is expensive and slow. Moreover, CVD diamond coatings have adhesion issues due to thermal coefficient mismatch with the metallic substrates to be coated, so that cracks are formed in the coating.

### SUMMARY OF THE INVENTION

The present invention relates to powder coating compositions suitable for use as lubricants for load bearing members in high temperature and/or high pressure environments. Advantageously, the present invention also provides powder coating compositions which can inhibit or reduce the rate of corrosion when the underlying substrate is a metal. Using the inventive coating compositions and application techniques described herein, one may obtain coatings that have low coefficient of friction, are wear resistant and thermally stable, and show good adhesion to substrate. In general, the coating compositions are in the form of a powder and do not contain volatile organic solvents. They can be applied on surfaces using simple techniques such as compression molding and thermal spraying. The powder compositions can also be molded into objects with high mechanical strength, good wear resistance, and low-friction surfaces.

In one aspect, the invention provides a bilayer coating. The coating comprises a bottom layer comprising a first thermoplastic polymer and particles of a first ceramic or particles of a first cermet or both. The coating also comprises a top layer comprising a second thermoplastic polymer and particles of a second ceramic or particles of a second cermet or both.

In another aspect, the invention provides a method of manufacturing a bilayer coating. The method comprises milling a first composition comprising a first thermoplastic polymer and particles of a first ceramic or particles of a first cermet or both to produce a first powder coating composition and milling a second composition comprising a second thermoplastic polymer, particles of a second ceramic or particles of a second cermet or both to produce a second powder coating composition. The method further comprises applying the first powder coating composition to a substrate to form a bottom layer; and applying the second powder coating composition on top of the first powder coating composition to form a top layer.

One aspect of the invention is to provide a powder composition. The powder composition comprises a thermoplastic polymer with a glass transition temperature of at least about 175° C., as well as at least one ceramic or at least one cermet. The powder composition is formed by milling the thermoplastic polymer and at least one ceramic or cermet together. The powder compositions can be applied to surfaces to make hard, low-friction coatings capable of withstanding high temperatures and/or high pressures. Alternatively, the powder compositions can be used for molding light-weight objects with high mechanical strength, low wear resistance, and surfaces with low coefficient of friction.

### BRIEF DESCRIPTION OF THE DRAWINGS

FIG. 1 depicts the differential scanning calorimetry data for poly(ether ether ketone) (PEEK) over the temperature range of 100° C. to 400° C. Data acquired during both the heating and the cooling steps are shown.

FIG. 2 shows the thermogravimetry data for PEEK under nitrogen and air environments. The data were acquired at a heating rate of 20° C./min.

FIG. 3 depicts a photograph of a dry composite powder (sample B, TABLE 1) containing PEEK (23 wt %) and WC/CoCr (77 wt %) and prepared by ball milling.

FIG. 4 depicts the SEM image of ball milled composite powder C (cf. TABLE 1) containing PEEK (28 wt %), WC/CoCr (50 wt %), and hBN (22 wt %).

FIG. 5 gives the thermogravimetry (TG) data for the powder samples (A) PEEK, (B) ball milled PEEK and WC/CoCr, and (C) ball milled PEEK, WC/CoCr, and hBN. The compositions of the samples are given in TABLE 1, and the TG data were acquired by heating the sample at a rate of 20° C./min under a nitrogen gas flow.

FIG. 6 depicts volume-weighted particle size distributions of powders of the as-received PEEK, PEEK and WC-760 composite (sample B), and PEEK, WC-760, and hBN composite (sample C), determined using Malvern Mastersizer 2000 laser diffraction particle size analyzer.

FIG. 7: (a) Cross sectional analyses of a bi-layer coating consisting of sample B (Table 1) as the bottom layer and sample C (Table 1) as the top layer at a magnification of 250×; (b) a higher magnification image of the bilayer at 1000×.

FIG. 8 shows the SEM images of PEEK particles before ball milling, acquired at (a) 100× magnification and (b) 500× magnification.

FIG. 9 shows the SEM images of (a) PEEK particles after ball milling and (b) a PEEK coating prepared by sintering the ball-milled PEEK particles at 400° C. and ambient pressure.

FIG. 10 shows SEM images of PEEK-SiO₂ composite coating (10 wt % silica) prepared by annealing the particles (a) between glass slides and (b) on a single glass slide. The films were prepared at 400° C. and ambient pressure.

FIG. 11 shows SEM images of (a) milled BN particles and (b) PEEK-BN composite coating prepared by annealing the composite particles between glass slides. The films were prepared at 400° C. and ambient pressure.

FIG. 12 is a schematic illustration of PEEK-cBN-hBN composite coatings deposited on the glass substrate (a) before and (b) after compression and thermal sintering.

FIG. 13 shows photographs of glass substrates coated with PEEK-cBN-hBN composite powders (a) before and (b) after thermal sintering.

FIG. 14 shows XRD patterns of PEEK, hBN, cBN and the composite coatings.

FIG. 15 compares the thermal stability of pure PEEK and the PEEK-cBN-hBN composite material.

FIG. 16 is an SEM image of molybdenum (IV) sulfide before ball milling.

FIG. 17 shows the SEM image of a ball milled composite powder consisting of PEEK and molybdenum (IV) sulfide.

FIG. 18 is an example of the effect of balling milling on particle size reduction. Particle size distributions of the as-received WC/CoCr particles (WC-760) and of the ball milled particles are shown.

FIG. 19 is a schematic illustration of a bilayer coating.

FIG. 20 shows SEM images of the cross-section of two different monolayer coatings consisting of: (a) 60 wt % PEEK, 20 wt % WC/CoCr, and 20 wt % hBN (sample D in TABLE 2), and (b) 45 wt % PEEK, 27.5 wt % WC/CoCr and 27.5 wt % hBN (sample G in TABLE 2).

FIG. 21 shows SEM images of the cross-section of five different bilayer coatings of compositions given in TABLE 3.

FIG. 22 compares the hardness of coatings of compositions D, E, F, and G given in TABLE 2, measured using nanoindentation in ambient conditions of temperature and humidity. The effect of ball milling the polymer, the cermet and the ceramic particles on the coating hardness is also seen.

FIG. 23 compares the reduced modulus of coatings of compositions D, E, F, and G given in TABLE 2, measured using nanoindentation in ambient conditions of temperature and humidity. The effect of ball milling the polymer, the cermet and the ceramic particles, on the coating modulus is also seen.

FIG. 24 shows the reduced modulus of the monolayer coatings of compositions, D, E, F, G, and H (given in TABLE 2), and bilayer coatings of compositions, J, K, L, M, and N (given in TABLE 3). Samples D, E, F, G, and H have the same overall compositions as samples J, K, L, M, and N, respectively.

FIG. 25 shows the coefficient of friction of the monolayer coatings of compositions, D, E, F, G, and H (TABLE 2), and bilayer coatings of compositions, J, K, L, M, and N (TABLE 3), measured under ambient conditions.

FIG. 26 shows the wear volume of the monolayer coatings of compositions, D, E, F, G, and H (TABLE 2), and bilayer coatings of compositions, J, K, L, M, and N (TABLE 3).

FIG. 27 shows cross-sectional SEM images of a glass substrate coated with PEEK-cBN-hBN composite powders by the drop casting method. The top and middle layers appear dense, but a porous middle layer is also seen.

### DETAILED DESCRIPTION

The present invention provides powder coating compositions, which when applied using the prescribed method, results in low-friction surface coatings capable of withstanding extreme conditions, including those of high temperature and/or high pressure.

Typically, the powder coating compositions of the invention contain a polymer. In certain implementations, the polymer is a thermoplastic polymer that acts as a binder for other components of the powder coating compositions, such as ceramic particles and/or cermet particles. The term “thermoplastic” in this context refers to polymers that soften and flow upon application of pressure and heat. Suitable thermoplastic polymers include those with a high glass transition temperature. The “glass transition temperature” of a polymer is defined as a critical temperature above which it softens significantly. When a material is heated above its glass transition temperature, its mechanical properties change from those characteristic of glasses to those characteristic of flexible plastics. Examples of suitable thermoplastic polymers include those with glass transition temperatures of at least about 160° C., about 165° C., about 170° C., about 175° C., about 180° C. or about 185° C. With suitable processing, as described herein, the polymer acts as both a binder and an adhesive that helps to ensure that the coatings adhere to the underlying substrate. In some embodiments of the invention, the thermoplastic polymer is crystalline. In this context, a crystalline polymer is a polymer that shows distinct melting and/or crystallization peaks in calorimetric measurements, and/or show distinct diffraction peaks in X-ray scattering measurements. Preferably, the thermoplastic polymer has a high melting point. For example, in certain embodiments of the invention, the polymer component has a melting point of at least about 250° C., at least about 275° C., at least about 300° C., or at least about 325° C. Non-limiting examples of thermoplastic polymers that are suitable for this invention include poly(ether ether ketone) (PEEK), poly(ether ketone) (PEK), poly(ether ketone ether ketone ketone) (PEKKEK), poly(amide imide) (PAI), poly(aryl sulfone), poly(ether imide) (PEI), poly(phenylene sulfide) (PPS), poly(ethylene terephthalate) (PET), poly(butylene terephthalate) (PBT), polycarbonate, polyacetal, Nylon 66, and Nylon 6.

The glass transition temperature, the melting temperature, and the crystallization temperature, can be determined by techniques known to a person skilled in the art, including differential scanning calorimetry (DSC) or dynamic mechanical analysis (DMA), and thermal stability can be characterized using thermogravimetry (TG). See, e.g., Principles of Thermal Analysis and calorimetry, P. J. Haines, Ed., The Royal Society of Chemistry, 2002. Polymer crystallinity and the dispersion of crystalline fillers in the polymer matrix can be characterized using X-ray diffraction (XRD). See, e.g., B. D. Cullity and S. R. Stock, Elements of X-ray Diffraction, 2nd ed., Addison-Wesley Publishing Company, 1978; C. Hammond, The Basics of Crystallography and Diffraction, 2nd ed., Oxford University Press, 2001.

The powder coating compositions of the invention may contain one or more fillers. The term “filler” refers to any solid material that is added to the coating formulation for imparting functional characteristics to the coating, including mechanical, tribological, chemical, and electrical properties. Examples of fillers include ceramic particles, cermet particles, carbon black, glass fibers, carbon fibers, asbestos, clay particles, etc.

In certain embodiments, the powder coating compositions of the invention may comprise ceramic particles. The term “ceramic” broadly refers to any class of inorganic, non-metallic product subjected to high temperature during manufacture or use. Ceramics are rigid materials that consist of a three-dimensional network of sintered crystalline grains comprising metals or metalloids bonded to carbon, nitrogen, oxygen, or sulfur. A metalloid is an element that has both metallic and nonmetallic properties. Examples of metalloids are boron, silicon, and arsenic. Aluminum oxide, tungsten carbides, molybdenum disulfide, and boron nitride are examples of ceramics.

In certain embodiments, the powder coating compositions of the invention also may comprise cermet particles. The term “cermet” refers to composite materials composed of ceramics and metals. The metallic materials used in cermets may include, for example, cobalt, chromium, nickel, molybdenum as well as combinations thereof. Non-limiting examples of cermets that are suitable for the coating compositions of the invention include tungsten carbide/cobalt (WC/Co), tungsten carbide/cobalt-chromium (WC/CoCr), chromium carbide/nickel-chromium (CrC/NiCr), and tungsten-chromium carbide/nickel-chromium.

In certain embodiments, the powder coating compositions of the invention are prepared by grinding and crushing mixtures of a thermoplastic polymer and at least one ceramic material and/or at least one cermet material. The techniques used to grind and crush such mixtures are not particularly limited and includes any technique by which one can grind and crush solid particles to form a powder. For example, in certain embodiments, the powder coating compositions are prepared by milling. Various types of milling may be used, including ball milling, cryomilling, hammer milling, pin milling, and jet milling. In general, the milling continues until an appropriate particle size distribution is reached. Particle size distribution can be determined using techniques such as dynamic light scattering (for particles with equivalent diameter below 1 μm) and laser diffraction methods such as Fraunhofer diffraction (for particles larger than approximately 3 μm) and polarization intensity differential scattering (covering a size range from nanometers to millimeters). See, e.g., John C. Berg, An Introduction to Interfaces and Colloids, World Scientific, 2009. The analysis is limited to quasi-spherical particle geometries, yielding a volume-weighted distribution of equivalent diameters. Equivalent diameter is defined as the diameter of a spherical particle which will give identical optical, mechanical, electrical, or fluid flow behavior to that of the non-spherical particle being examined. Particles with sizes in the micrometer and nanometer range can be observed using optical microscopy or field emission scanning electron microscopy using equipment such as a JEOL 7400 high resolution electron microscope. See, e.g., J. Goldstein, D. E. Newbury, D. C. Joy, C. E. Lyman, P. Echlin, E. Lifshin, L. Sawyer, J. R. Michael, Scanning Electron Microscopy and X-ray Microanalysis, 3rd ed., Springer, 2007.

In one embodiment, the particles in the powder after ball milling have a volume-weighted mean equivalent diameter of between 1 and 100 μm as determined using the laser diffraction technique. For example, the mean equivalent diameter of such particles may be between 0.2 μm and 80 μm. In certain embodiments, the particles of the powder coating composition after milling may have a mean equivalent particle diameter below 10 μm, below 5 μm, below 1 μm, or below 0.5 μm. For example, the mean equivalent particle diameter may range from about 0.1 μm to about 100 μm, or about 0.2 μm to about 80 μm, or about 0.5 μm to about 50 μm; or about 1 μm to about 30 μm. In some embodiments, the mean equivalent particle diameter may range from about 1 μm to about 80 μm, about 5 μm to about 70 μm, or about 10 μm to about 60 μm. One aspect of the invention is the recognition that one can obtain coatings with suitable hardness, wear, and anti-friction properties by co-milling a thermoplastic polymer, at least one ceramic and/or at least one cermet, without the need of nanoparticles of characteristic diameters of about 0.5 μm or less.

The weight percentage of the thermoplastic polymer the powder coating compositions of the invention may vary over a wide range, and is not particularly limited, as long as the amount of thermoplastic polymer is sufficient to provide sufficient adhesion to the coating layer after processing and to bind the ceramic or cermet particles (or both) that may be present in the coating composition. For example, in some embodiments, the weight percentage of the thermoplastic polymer is in the range of about 30% to about 95%, about 40% to about 85%, about 50% to about 75% or about 60%.

The weight percentage of the ceramic or cermet components of the powder coating compositions may vary over a wide range and are chosen to meet the desired low-friction, hardness, and/or wear properties required for a particular application. For example, the cermet or ceramic materials may be present in a weight percentage range that results in a coating with a hardness of at least about 0.1 GPa, at least about 0.2 GPa, at least about 0.4 GPa, at least about 0.6 GPa, or at least about 1.0 GPa. In certain embodiments, the cermet or ceramic materials are present in a weight percentage range that results in a coating with a coefficient of friction in the range of about 0.05 to about 0.4, or about 0.1 to about 0.3, or about 0.1 to about 0.2. The cermet or ceramic materials may also be present in a weight percentage range that results in coatings with high nanoindentation reduced modulus, in the range of 3 to 10 GPa, and high nanoindentation hardness, in the range of 0.2 to 0.8 GPa. Accordingly, some useful weight percentage ranges of the ceramic or cermet components of the powder coating composition are from about 5% to about 75%, or about 15% to about 40% or about 20% to about 35%.

Coating hardness and Young's modulus can be measured using the nanoindentation technique. See, e.g., A. C. Fischer-Cripps, Nanoindentation, 3^{rd} ed., Springer, 2011. The analysis of the load-displacement data yields the value of reduced modulus, Eᵣ, which is related to the Young's modulus, E, and Poisson's ratio, ν, of the coating through E≅Eᵣ(1−ν²) [W. C. Oliver, G. M. Pharr, Measurement of hardness and elastic modulus by instrumented indentation: Advances in understanding and refinements to methodology, Journal of Materials Research, 29, pp. 3-20, 2004; A. Sreeram et al. Nanomechanical properties of poly(para-phenylene vinylene) determined using quasi-static and dynamic nanoindentation, Polymer Testing, 37, pp. 86-93, 2014].

The tribological properties, namely friction and wear, can be determined using test methods such as the ASTM G133 standard for linearly reciprocating ball-on-flat sliding wear [ASTM G133-05, In Standard Test Method for Linearly Reciprocating Ball-on-Flat Sliding Wear, ASTM International: West Conshohocken, Pa., 2010]. Wear is defined as the removal of material from a surface that is sliding contact with a hard counterface. In a wear process, surface damage of the material occurs through the formation of loose wear particles, or by transfer of the material from the surface to the counterface. Wear processes have been classified into the following categories: abrasive wear, adhesive wear, transfer wear, chemical wear, fatigue wear, fretting wear, erosion, and delamination wear. See, e.g., B. J. Briscoe and S. K. Sinha, Tribological applications of polymers and their composites—past, present and future prospects, In Tribology of Polymeric Nanocomposites, 2^{nd} ed., K. Friedrich and A. K. Schlarb, Eds., Elsevier, 2013.

The powder coating compositions of the invention are applied to substrates in need of such coatings (e.g., gate valves, piston rings, etc.) in order to form a coating that comprises at least one layer. In the context of coating layer formation, the “top” of the coating refers to the coating interface that is in contact with air or the environment of use. The “bottom” of the coating refers to the coating interface that is in contact with the substrate, metallic or nonmetallic. Typically, the powder coating compositions are applied under high temperature conditions sufficient to soften or melt the thermoplastic polymer temporarily. In this way, the resulting coating layer adheres to the surface upon which it is applied. In one exemplary embodiment, the powder coating compositions are applied to a substrate by thermal spraying the powder coating compositions towards a surface.

Currently, there are several types of thermal spray processes, including combustion flame spray (wire, rod, and powder spray), high-velocity oxy fuel (HVOF), electric arc wire spray (air or inert gas), and plasma spray (air, vacuum, or inert atmosphere). See, e.g., Handbook of Thermal Spray Technology, J. R. Davis, Ed., ASM International, 2004, Chapter 20, p. 175-213; and P. L. Fauchais et al. Thermal Spray Fundamentals: From Powder to Part, DOI 10.1007/978-0-387-68991-3_2, Springer: New York, 2014. In the combustion flame spray technique, combusting oxygen and fuels are used to melt the coating composition, in the form of a solid wire, rod, or a powder, and the molten droplets are atomized and accelerated onto an appropriate substrate using compressed air or inert gas. The HVOF technique also uses fuel combustion as the heat source, but produces very high-velocity gas streams compared with combustion flame spraying. The wire electric arc spraying uses two electrically conducting wires as feedstock and is restricted to conductive materials. Plasma spraying uses an electric arc to generate very high-temperature gas plasma jet.

The combustion powder flame spraying and HVOF techniques are particularly suited for applying the powder coating compositions of the invention. The powders of the invention can be extruded to obtain wires or rods that can subsequently be used in the combustion-wire spraying and combustion-rod spraying techniques. They have sufficient thermal stability to withstand the high temperatures involved in these thermal spray processes. See, e.g., L. Pawlowski, Physics and Chemistry of Thermal Spraying. In The Science and Engineering of Thermal Spray Coatings: Second Edition, John Wiley & Sons, 2008, Chapter 5.

Plasma spraying methods are generally unsuitable for coating substrates with carbon-based polymers when plasma temperatures are greater than 800° C., since the carbon-based polymers tend to degrade under such conditions. By contrast, although the flame temperature is high in the HVOF process, the particle velocities in the jet are supersonic, in the range of 610 m/s to 1060 m/s [J. R. Davis, ibid.], so that the residence time of the polymer in the flame is small, and polymer thermal degradation is not significant. Also, in comparison with physical vapor deposition (PVD), which is also usually carried out at temperatures above 400° C., thermal spray coating has the advantage that thicker coatings (10-10000 μm) can be obtained in a significantly shorter time.

Other methods of applying the powder coating compositions to a surface are also contemplated by the invention, such as compression molding, which involves introducing the powder coating compositions into a heated compression mold. Microwave sintering and inductive heating are other techniques that can be used to melt the polymer in the powder coatings and make them adhere to substrates. In addition, this invention contemplates compression molded articles (with no underlying substrate) that are formed by compression molding the powder compositions of the invention. Like the coating of the invention, such compression molded articles are wear-resistant and exhibit a low coefficient of friction on their surfaces. In certain embodiments, the compression molding (either of an article of a coating) is performed using a pressure of about 5 tons, about 10 tons, about 15 tons, or about 25 tons to compress the powder compositions of the invention. Optionally, the compressions can occur in cycles. For example, in one embodiment, the powder compositions of the invention may be compressed at a force of 5 tons for one minute, a force of 10 tons for a minute, and a force of 20 tons for 10 minutes. Optionally, the powder compositions may be heated during the compression steps or in between compression steps, typically to a temperature above the glass transition temperature of the thermoplastic polymer in the powder compositions. Using these conditions, it is possible to achieve articles or layers that are hard and have low porosity and outer surfaces with low friction.

In some embodiments of the invention, different powder coating compositions of the invention may be applied sequentially to form a multilayer coating. For example, in one implementation, two different powder coating compositions are applied sequentially to form a bilayer coating. In such an implementation, powder coating composition corresponding to the first layer is advantageously chosen to maximize adhesion to the underlying substrate and to provide mechanical strength and hardness, while the powder coating composition of the second layer is chosen to minimize the coefficient of friction of, and the wear on, the coating surface. For example, the first layer may comprise a thermoplastic polymer comprising PEEK and a cermet such as WC/CoCr. The second layer may comprise a thermoplastic polymer, such as PEEK, and a ceramic such as hexagonal boron nitride (h-BN). Preferably, such a bilayer has cermet or ceramic particles that have an equivalent particle diameter below 10 μm. Also, preferably, such a bilayer has a hardness value of at least approximately 0.6 GPa, reduced modulus of at least approximately 8 GPa, and a coefficient of friction not greater than about 0.15.

The thicknesses of the coating layers that can be made using the powder coating compositions of the invention are not particularly limited and will depend on the particular application. For example, in some embodiments, the thicknesses of the coating layers are in the range of about 1 to about 10 μm, about 2 to about 8 μm, or about 3 to about 5 μm. However, the invention also contemplates embodiments in which the coating layers have thicknesses in the range of about 10 to about 800 μm, about 50 to about 700 μm, or about 400 to about 600 μm, or about 2 to about 500 μm. In certain embodiments, the invention contemplates polishing the top coating layer after it has been applied. Polishing generally involves physically rubbing the surface of the top layer with an abrasive object. It is desirable in some cases to use series of abrasive objects with successively finer grit. Coatings layers using that powder coating compositions of the invention and having a coefficient of friction of about 0.15 can be achieved in this way.

The following examples are intended to illustrate the above invention and should not be construed as to narrow its scope. One skilled in the art will readily recognize that the examples suggest many other ways in which the present invention could be practiced. It should be understood that many variations and modifications may be made while remaining within the scope of the invention.

### EXAMPLES

### Example 1

### Characterization of Crystallinity of the Thermoplastic Polymer

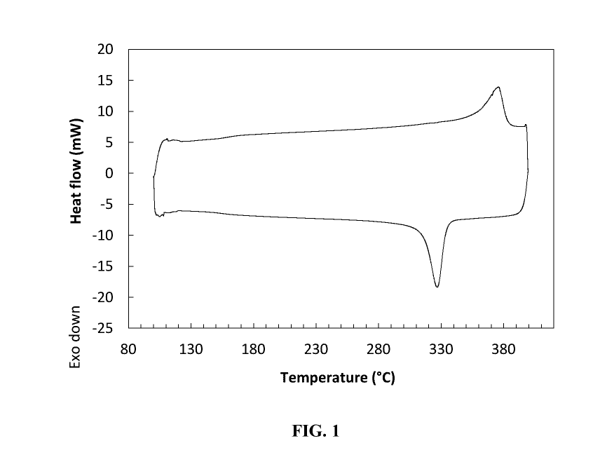

Differential scanning calorimetry (DSC) was performed using a TA Instruments Q100 differential scanning calorimeter for characterizing the glass transition, melting, and crystallization transitions of the thermoplastic polymer. PEEK (VICOTE 701 supplied by VICTREX in the form of 50 μm sized powder particles) was dried at 120° C. in a vacuum oven for 24 hours before the DSC analysis. The sample, which was loaded in a hermetically sealed aluminum pan, was heated and cooled at a constant rate of 25° C./min over a temperature range of 100 to 400° C. The measurements were carried out under nitrogen flow, at a rate of 50 cm³/min, through the furnace. Distinct melting and crystallization peaks were observed in the resulting DSC thermogram. FIG. 1 depicts data acquired during the second cycle of heating and cooling. A glass transition at approximately 175° C., a melting transition at approximately 375° C., and a recrystallization transition at approximately 330° C. were observed.

### Example 2

### Thermogravimetric Analysis (TGA)

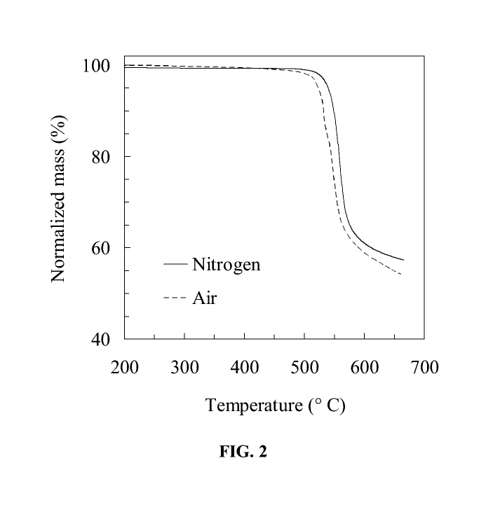

Thermogravimetry (TG) of a high molecular weight PEEK was conducted using a heating rate of 20° C./min. The high molecular weight PEEK was found to have excellent thermal stability. FIG. 2 compares the thermogravimetric plots for PEEK, acquired by heating the polymer under an inert environment of nitrogen gas and an oxidative environment of air. The thermal stability of PEEK in air was slightly lower than that in nitrogen. However, the thermal decomposition temperature was sufficiently high such that the coatings can be used in high temperature applications or can be applied using thermal spray processes.

### Example 3

### Particle Size Reduction and Compounding Using Ball Milling

The composite powders were prepared by ball milling in two steps. In the first step, PEEK (VICOTE 701 supplied by VICTREX in the form of approximately 60 μm sized powder particles, 75 g) was dispersed in ethanol (99.9% purity, 300 mL) and ball milled for 24 hours, in a U. S. Stoneware Jar Mill using a combination of steel balls of three different diameters (25, 15, and 10 μm). After milling, the solid was allowed to settle down, the supernatant ethanol was decanted, and the powder was dried overnight in a vacuum oven at 110° C. Ball milled powder of the cermet, WC/CoCr [WC-760, CAS no. 7440-48-4, consisting of tungsten (79.8 wt %), cobalt (10.7 wt %), carbon (5 wt %), and chromium (4.5 wt %), supplied by Praxair, Inc.], and the ceramic, hexagonal boron nitride (hBN, CAS no. 10043-11-5, supplied by Industrial Supply, Inc., Twin Falls, Id.) were prepared similarly Dry powders were obtained by evaporation of ethanol (from the wet mass of the solids that settled due to gravity upon standing) in a vacuum oven at 110° C. The ball milled PEEK, WC/CoCr, and hBN powders were dispersed in ethanol, and the slurry was further ball milled for 10 hours and worked up to obtain solid powders. TABLE 1 gives the compositions of the three powder samples prepared using this procedure.

TABLE 1
Powder coating compositions

| | PEEK | WC/CoCr | hBN |
|---|---|---|---|
| Sample | (wt %) | (wt %) | (wt %) |
| A | 100 | 0 | 0 |
| B | 23 | 77 | 0 |
| C | 28 | 50 | 22 |

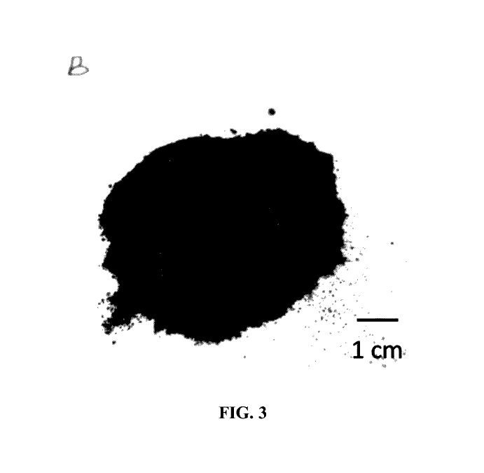

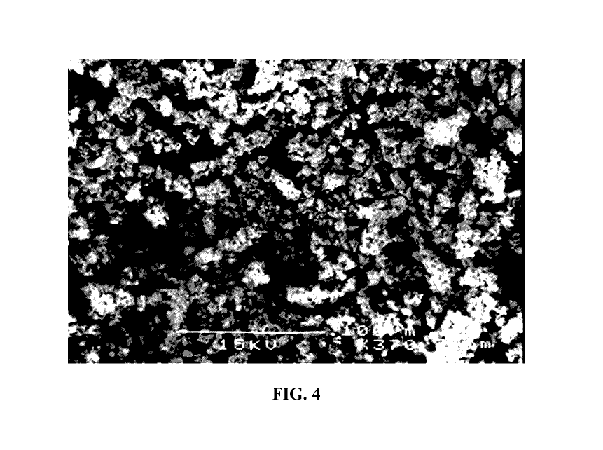

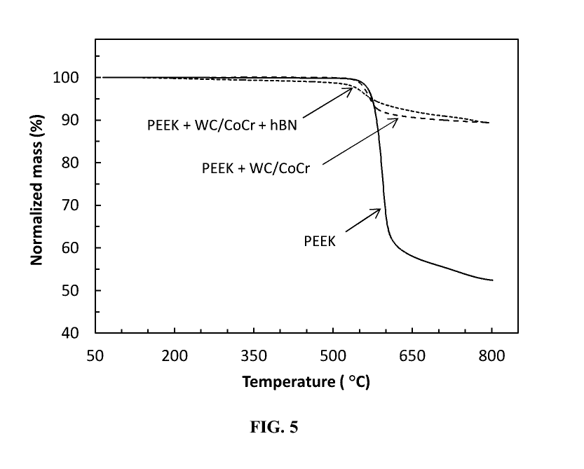

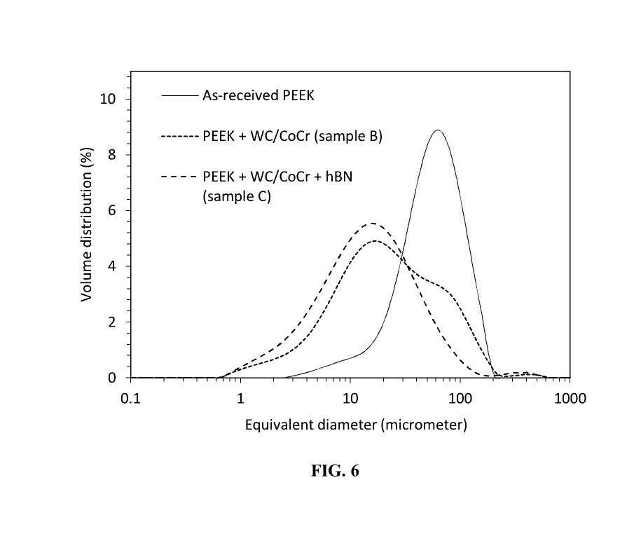

FIG. 3 depicts a photograph of a dry composite powder (sample B, TABLE 1) comprising of PEEK and WC/CoCr, prepared using the said ball milling procedure. FIG. 4 depicts the SEM image of ball milled composite powder C (cf. TABLE 1) containing PEEK, WC/CoCr, and hBN. FIG. 5 shows the thermogravimetry data for the powder samples A, B, and C (cf. TABLE 1), acquired using a flow of nitrogen gas through the furnace. It is evident that all of the samples exhibited significant thermal stability, up to temperatures as high as 350° C. FIG. 6 depicts volume-weighted particle size distributions of powders of the as-received PEEK (sample A), PEEK and WC-760 composite (sample B), and PEEK, WC-760, and hBN composite (sample C), determined using Malvern Mastersizer 2000 laser diffraction particle size analyzer. The mean equivalent particle diameter was 63 μm for as-received PEEK, 36 μm for ball-milled sample B consisting of PEEK and WC/CoCr particles, and 24 μm for sample C consisting of PEEK, WC/CoCr, and hBN particles.

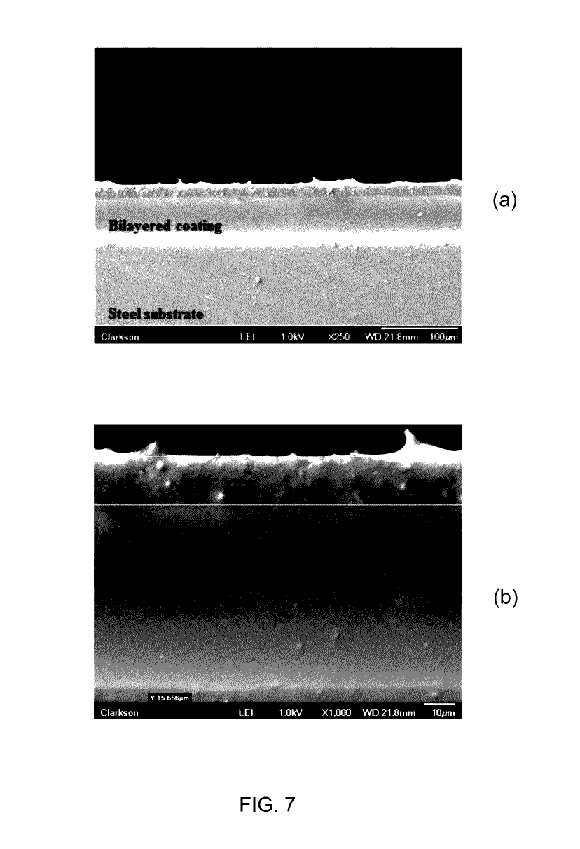

A monolayer coating of the powder sample B (Table 1) was prepared on a 0.08″ thick 4130 alloy steel substrate using compression molding. The steel plates were polished using a Buehler Ecomet III Polisher-Grinder and CarbiMet polishing pads (of grit sizes 180/P180 to 240/P280) before application of the coating. About 2 g of the powder was placed on each of the four 2″×2″ steel plates assembled in a mold preheated to 150° C. Heating the powder to 400° C. under a load of 25 tons for 30 minutes resulted in the formation of a uniform coating on the steel substrate. The mold was cooled to a temperature below 100° C. before removal of the coated sheet from the mold. FIG. 7 shows a cross-sectional SEM image of a bilayer coating prepared on a 4130 steel substrate using compression molding. The bilayer coating consisted of PEEK and WC/CoCr (sample B, 2 g) in the bottom layer and PEEK, WC/CoCr, and hBN (sample C, 1.5 g) in the top layer, on top of a 2″×2″ 4130 alloy steel substrate. The mechanical and tribological properties of the coatings are reported in TABLE 4 and TABLE 5 of Examples 13 and 14, respectively.

### Example 4

### PEEK-SiO₂ Composite

The PEEK-silica nanocomposite dispersions were prepared using a ball milling process in which fumed silica and PEEK powder were combined with isopropanol and ¼ inch, 440C stainless steel balls in a 125 mL mill jar. Specifically, a PEEK-silica nanocomposite containing 40 vol % silica was prepared by combining 2.01 g PEEK, 2.68 g fumed silica, and 25 mL of isopropanol. Next, ball-milled PEEK (pure polymer) was combined with the ball-milled PEEK-silica composite (40 vol % silica) to arrive at a final suspension containing 10 wt % silica and 90 wt % PEEK.

### Example 5

### PEEK and Hexagonal Boron Nitride (hBN) Composite Powder

Hexagonal boron nitride received from Industrial supply, Inc, Twin Falls, Id., was used. As in the case of the PEEK-silica material, the PEEK-hBN suspension was prepared by blending ball milled PEEK and ball milled hBN into a uniform suspension. The solid phase of the suspension contained 5 wt % BN and 95 wt % PEEK.

### Example 6

### Films Prepared by Thermal Sintering of PEEK-hBN Composite Powders

The PEEK powder was processed in a ball mill to decrease average size of the particles from approximately 60 μm in the as-received PEEK to about 10 μm. Hexagonal boron nitride particles were milled to an equivalent particle diameter of 370 nm. A suspension of the ball milled PEEK particles was formulated and spray coated on the surface of a glass microscope slide to obtain a coating of pure PEEK polymer. The boron nitride suspension was blended with the suspension of PEEK (as described in Example 5). The composite suspension was spray coated on the surface of another glass slide.

The annealing process consisted of two stages. (1) Green Compact Formation—The films were annealed at 175° C. (above the glass transition temperature of PEEK) for 30 minutes under applied pressure. The applied pressure caused deformation and compaction of the particles in the coating. (2) Film Synthesis—The compacted films were further annealed at 375° C. for 25 min under ambient pressure. PEEK melted at this temperature causing further densification of the compacted film.

### Example 7

### Characterization of Particles Using Scanning Electron Microscopy (SEM)

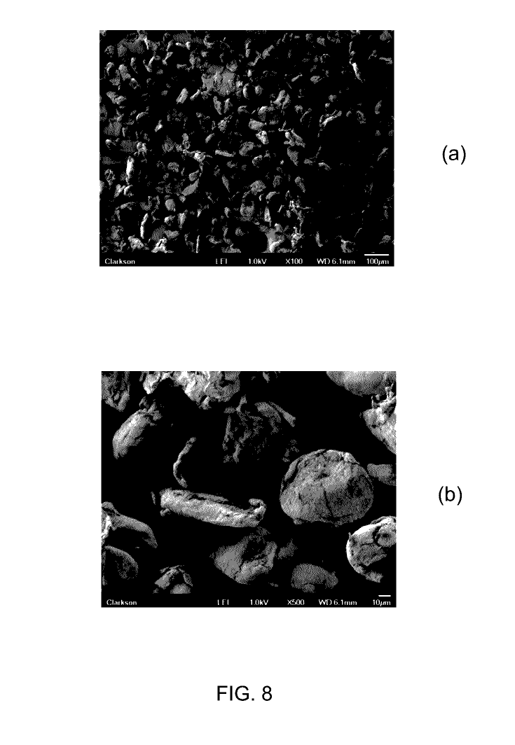

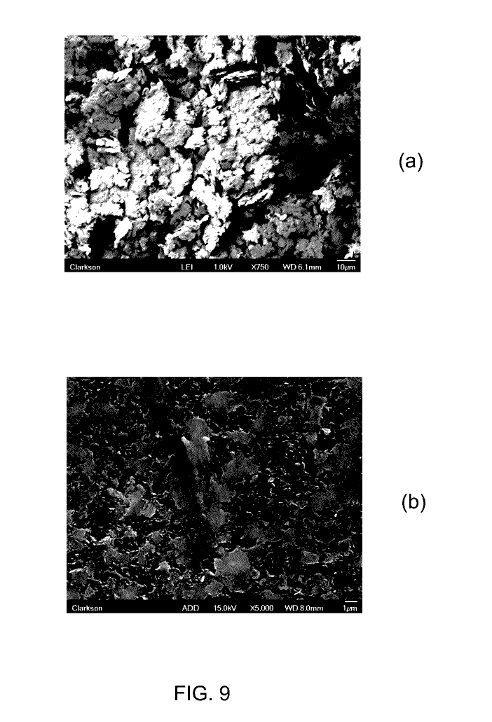

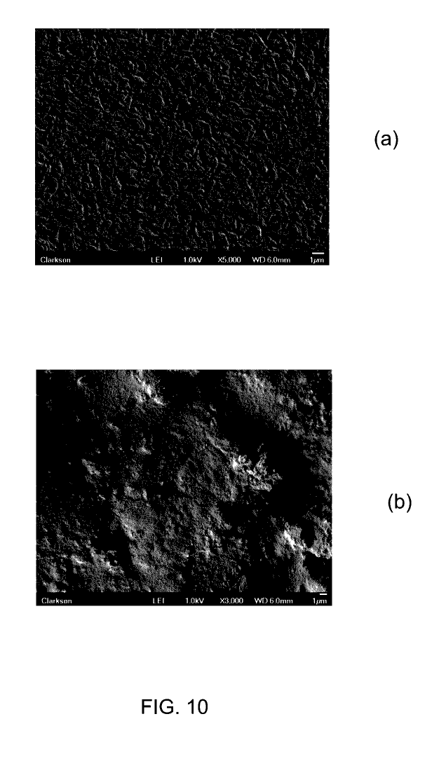

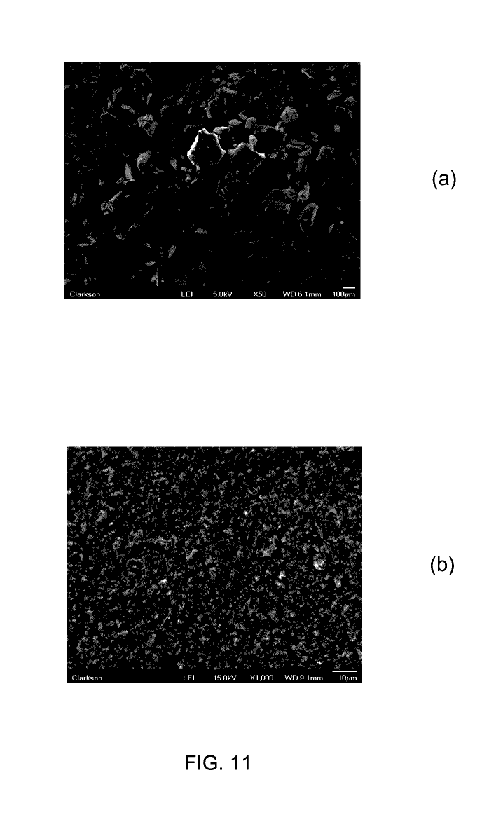

SEM was used to characterize particle size and morphology of the ball milled particles. For the analysis of a powder sample, the particles were deposited on an adhesive carbon tape attached to a steel stub. In the case of coatings, the coated substrates were directly attached to the steel stub. The samples were sputter coated (for 45 seconds) with an ultrathin layer of gold. FIG. 8 shows the SEM images of the as-received high molecular weight PEEK particles, and FIG. 9 shows the SEM images of the ball-milled PEEK particles, and a coating obtained by thermal sintering of the polymer on a glass substrate. FIG. 10 shows the SEM images of PEEK-silica composite coating (10 wt % silica; cf. Example 4) prepared by sintering the particles on a glass slide at 400° C. and ambient pressure. FIG. 11 shows the SEM images of PEEK-hBN composite coating prepared by sintering the particles on a glass slide at 400° C. and ambient pressure.

### Example 8

### PEEK, Cubic Boron Nitride, and Hexagonal Boron Nitride Composite Powders and Coatings

Coatings consisting of PEEK, cubic boron nitride (cBN) and hexagonal boron nitride (hBN) were prepared and characterized. Multiple layers were incorporated into the film: an underlying PEEK-cBN layer to provide high strength and a top PEEK-hBN layer to impart friction resistance. The composite precursor materials were prepared by ball milling cBN particles with PEEK in isopropanol. In this process, the PEEK and cBN particles were first ball milled separately. Once sufficiently small, the PEEK and cBN particles were ball milled together yielding a single composite powder that was 70 vol % cBN and 30 vol % PEEK.

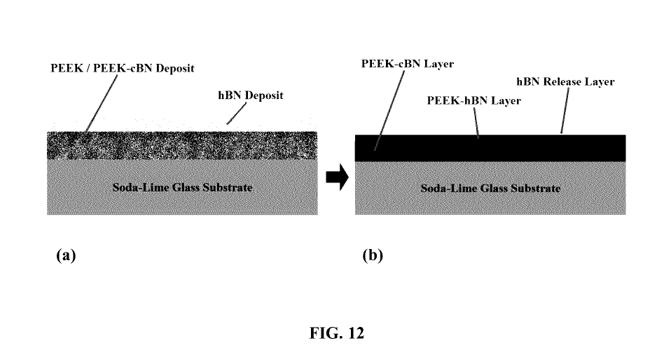

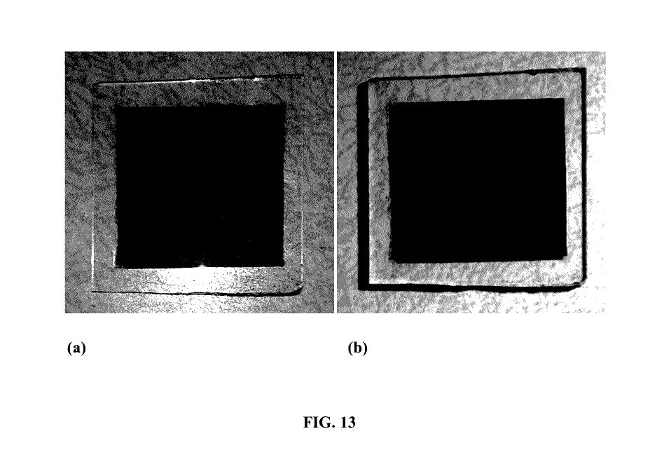

Previously milled PEEK powder was added to the PEEK-cBN composite powder to form precursor slurries in isopropanol. Suspensions containing 17 vol %, 23 vol %, and 30 vol % cBN (and 83 vol %, 77 vol %, and 70 vol % PEEK, respectively) were prepared and spray coated onto soda-lime glass (SLG) substrates. Ball milled hBN suspension was sprayed on top of the precursor films, creating a layered precursor coating. The spray-coated layers were allowed to dry at room temperature, and then heated for a period of about 50 min at 390° C. under an applied pressure of about 40 MPa. FIG. 12 shows a schematic of this process. FIG. 13 shows the photographs of the coating before and after heat treatment.

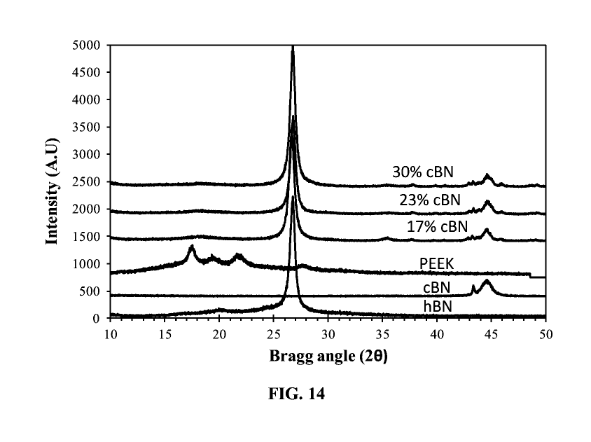

X-ray diffraction (XRD) patterns were obtained from the composite coatings and compared to those obtained from pure hBN, pure cBN, and pure PEEK samples. FIG. 14 shows the X-ray diffraction patterns of hBN, cBN, PEEK, as well as composite films containing various amounts of cBN by volume. The diffraction peaks of the hBN and cBN nanoparticles are clearly seen in the XRD plots of the composite films. However, the diffraction peaks, characteristic of crystalline PEEK, were not evident, indicating that the degree of crystallinity of the polymer in the films is low. The low degree of crystallinity is attributed to intermolecular interaction with the filler particles on a nanoscale.

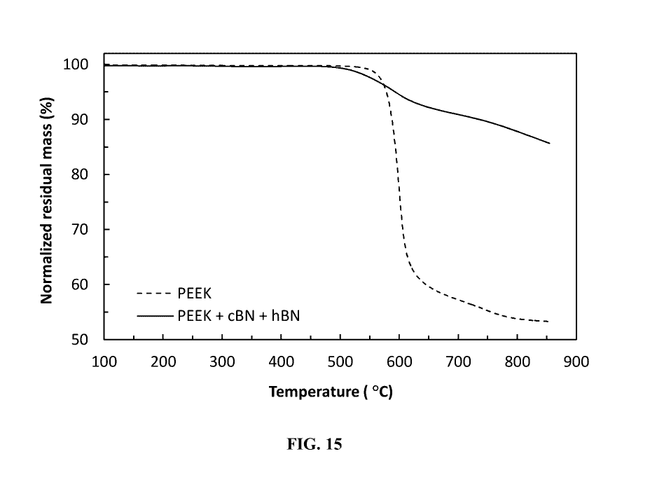

The thermogravimetry data, shown in FIG. 15, indicate good thermal stability of the powder samples, up to a temperature of approximately 400° C.

### Example 9

### PEEK and Molybdenum Sulfide Composite Powders

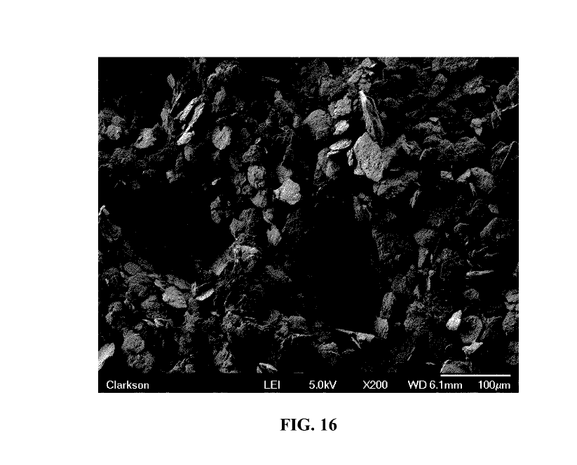

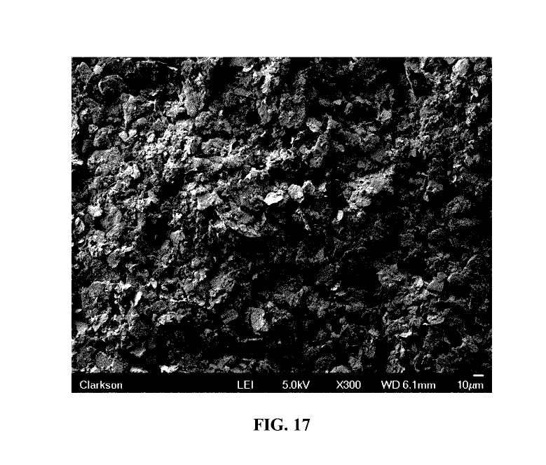

A sample of molybdenum (IV) sulfide (MoS₂) was ball milled in ethanol for about 24 hours and then further milled overnight with a previously milled PEEK. The composite powder thus obtained, was dried for 24 hours at 120° C. and characterized. It contained about 75 vol % of MoS₂ and particles with equivalent diameters ranging from 50 μm to 600 μm. FIG. 16 shows an SEM image of the as-received MoS₂ particles and FIG. 17 shows an SEM image of the PEEK and MoS₂ composite powder.

### Example 10

### Planetary Ball Mill

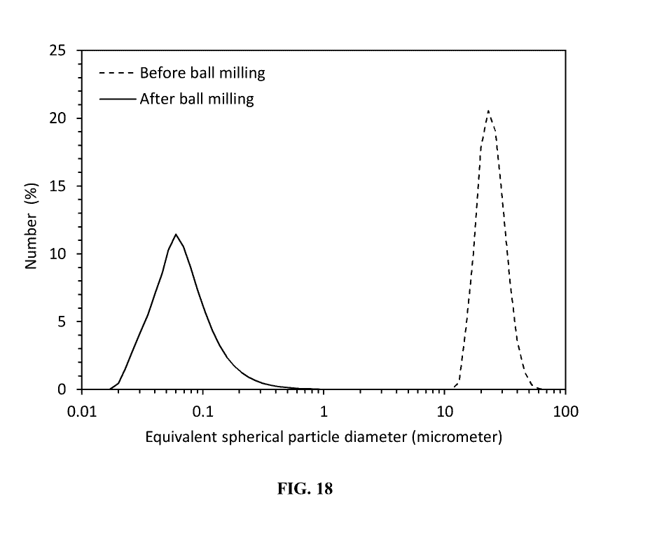

In order to achieve particle size reduction, the components were milled individually in a planetary ball mill (PQ-N2 planetary ball mill, Across International, Berkeley Heights, N.J.) for 10 hours, at 40 Hz and 500 rpm, changing rotating directions every 30 minutes. Steel balls with diameters in the range of 3 μm to 25 μm were used as the milling media. After milling, the samples were dried at 100° C. and the particle size was analyzed by laser diffraction. A significant reduction in particle size was observed. FIG. 18 shows the particle size distributions of the as-received WC/CoCr particles (WC-760) and of the ball milled particles. Several composite powders, of compositions shown in TABLE 2 were subsequently prepared.

TABLE 2
Compositions of composite powders prepared using the planetary ball mill

| Sample | PEEK (wt %) | WC/CoCr (wt %) | hBN (wt %) |
|---|---|---|---|
| D | 60.0 | 20.0 | 20.0 |
| E | 55.0 | 22.5 | 22.5 |
| F | 50.0 | 25.0 | 25.0 |
| G | 45.0 | 27.5 | 27.5 |
| H | 40.0 | 30.0 | 30.0 |
| I | 35.0 | 32.5 | 32.5 |

### Example 11

### Compression Molding

The composite powders were coated on 2″×2″ 4130 alloy steel substrates using a WABASH compression molding press (model no. 25-1212-2TMBX). A mold release coating was first sprayed on the surface of a custom-built steel mold. The steel substrates were polished using CarbiMet polishing pads (of grit sizes 180/P180 to 240/P280) and a Buehler EcoMet III Grinder-Polisher (Buehler, Lake Bluff, Ill.). The steel substrates were placed in the mold and preheated to 150° C. before loading the vacuum dried composite powder. Each mold cavity was loaded with about 2 g of the composite powder. The mold was closed, and sequentially compressed and decompressed to eliminate trapped air. The temperature of the mold was increased at a constant rate to 400° C. under no applied load (in approximately 30 min). The samples were maintained at this temperature under compression (25 tons load) for 30 min, after which they were cooled to a temperature below 100° C. and then removed from the mold. After molding, the coated sheets were polished using an aqueous dispersion of alumina particles of 0.05 μm diameter, and a polishing pad (Microcloth, catalog #40-7208, Buehler). Unless stated otherwise, all coatings were prepared using this general procedure.

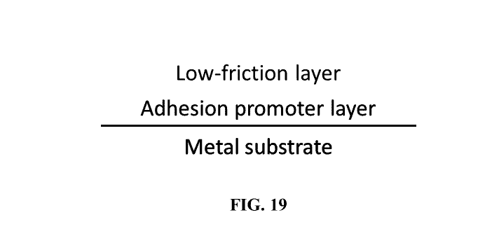

In the case of coatings with the bilayer architecture, the lower layer contained PEEK and WC/CoCr, while the top layer consisted of PEEK, WC/CoCr, and hBN. FIG. 19 shows a schematic of a bilayer coating.

### Example 12

### Cross-Sectional Scanning Electron Microscopy of Compression Molded Films

Samples for cross-sectional SEM analysis were cut from the coated steel substrates using a diamond saw (Buehler, Inc.) and embedded in an epoxy mold. They were polished using sand papers of various grit sizes to remove excess epoxy and to expose the surface to be imaged.

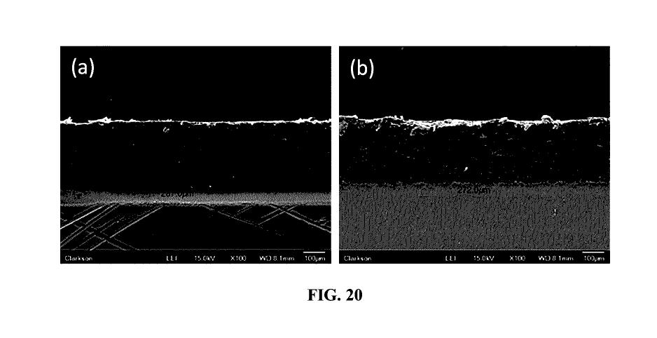

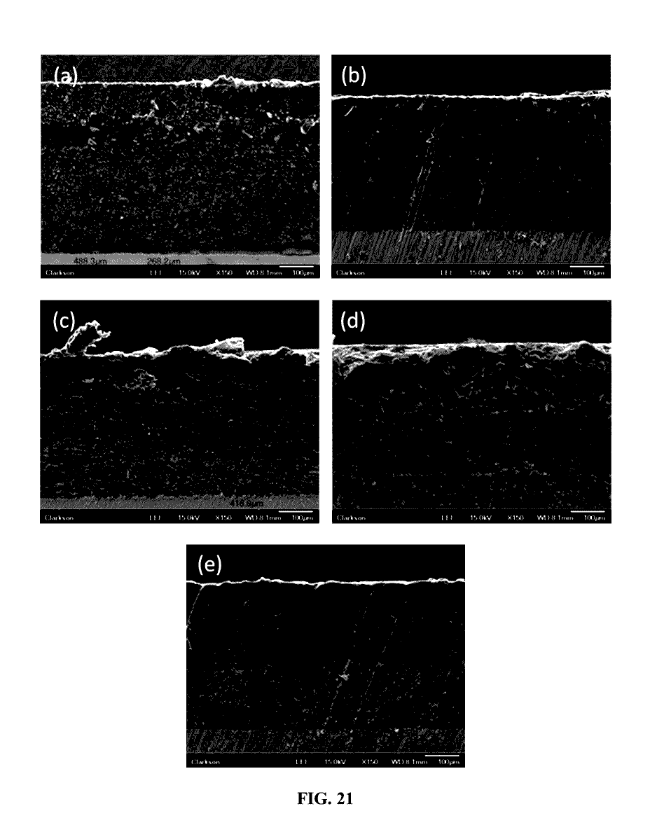

FIG. 20 shows SEM images of the cross-section of monolayer coatings consisting of: (a) 60.0 wt % PEEK, 20 wt % WC/CoCr, and 20 wt % hBN (sample D in TABLE 2), and (b) 45.0 wt % PEEK, 27.5 wt % WC/CoCr and 27.5 wt % hBN (sample G in TABLE 2). FIG. 21 shows SEM images of the cross-section of five different bilayer coatings of the compositions given in TABLE 3. The top and the bottom layers are clearly seen in these images. It is also evident that the coating process resulted in dense coatings, free of voids, and with good adhesion to the steel substrate.

Coatings with a combined thickness in the range of 350 μm to 500 μm were observed. The thickness of the individual layers varied in the range of 100 μm to 310 μm. The coating thickness can be readily modified by changing the amount of powder charged to the mold (or the amount of powder sprayed in a spray-coating process).

TABLE 3
Compositions of coatings with bilayer architecture

| | Top layer composition | | | Bottom layer composition | | |
|---|---|---|---|---|---|---|
| | (wt %) | | | (wt %) | | |
| Sample | WC/CoCr | hBN | PEEK | WC/CoCr | hBN | PEEK |
| J | — | 40 | 60 | 40 | — | 60 |
| K | — | 45 | 55 | 45 | — | 55 |
| L | — | 50 | 50 | 50 | — | 50 |
| M | — | 55 | 45 | 55 | — | 45 |
| N | — | 60 | 40 | 60 | — | 40 |

### Example 13

TABLE 4 gives the values of hardness and reduced modulus of the coatings of powder samples A, B, and C (see TABLE 1 for compositions) on steel substrates. These coatings are denoted by A1, B1, and C1, respectively. Coatings A1 and B1 were monolayer coatings of pure PEEK, and PEEK and WC/CoCr composite, respectively. Coating C1 was a bilayer coating consisting of PEEK and WC/CoCr in the base layer and PEEK, WC/CoCr, and hBN in the top layer. The coatings were not polished after compression molding. The mechanical properties of the coatings were determined at room temperature using the quasistatic nanoindentation technique. The average and standard deviations from 50 measurements are reported. The composite coatings showed significantly higher hardness and modulus values (up to 120% and 220%, respectively) compared with the PEEK polymer.

TABLE 4
Hardness and modulus of coatings determined using nanoindentation

| | A1 | B1 | C1 |
|---|---|---|---|
| Indentation hardness (GPa) | 0.25 ± 0.02 | 0.38 ± 0.01 | 0.55 ± 0.02 |
| Reduced modulus (GPa) | 4.4 ± 0.3 | 9.6 ± 0.4 | 14.0 ± 0.4 |

### Example 14

TABLE 5 gives the values of hardness and reduced modulus of the coatings A1, B1, and C1 of Example 13. The composite coatings, B1 and C1, exhibited a lower friction coefficient and lower wear volume compared with the unfilled PEEK coating, A1.

TABLE 5
Coefficient of friction and wear volume determined using a
modified ASTM G133 test procedure

| | A1 | B1 | C1 |
|---|---|---|---|
| Coefficient of friction | 0.48 | 0.46 | 0.37 |
| Wear volume (mm³) | 0.0291 | 0.0118 | 0.0083 |

### Example 15

### Effect of Ball Milling of the Composite Powders on Coating Properties

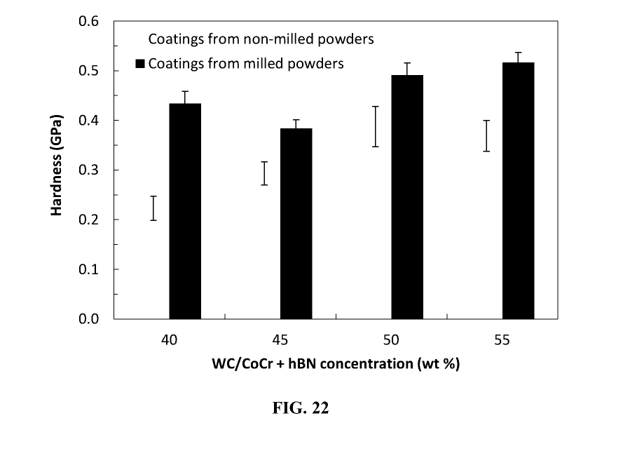

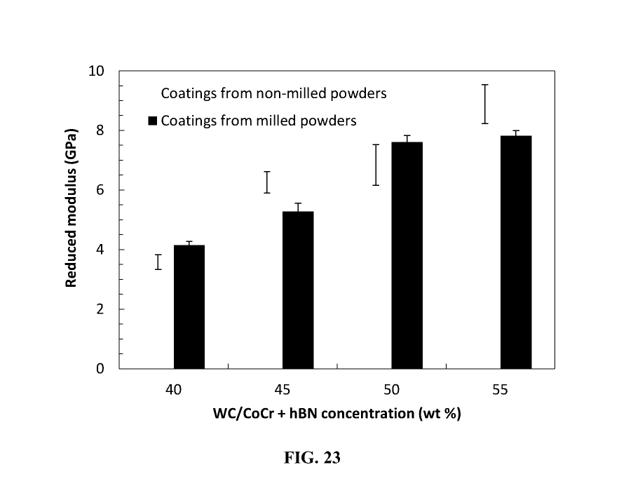

FIG. 22 shows the effect of ball milling process on the nanoindentation hardness of the composite coatings. A significant increase in the coating hardness was observed in the case of the ball milled powders, which is attributed to a reduction in the particle size and an increase in the polymer—filler interfacial area upon ball milling. The hardness reported in FIG. 22 are for monolayer coatings of compositions, D, E, F, and G given in TABLE 2. The corresponding values of reduced modulus are shown in FIG. 23. The modulus increased with an increase in the cermet and ceramic concentration in the composite coating.

### Example 16

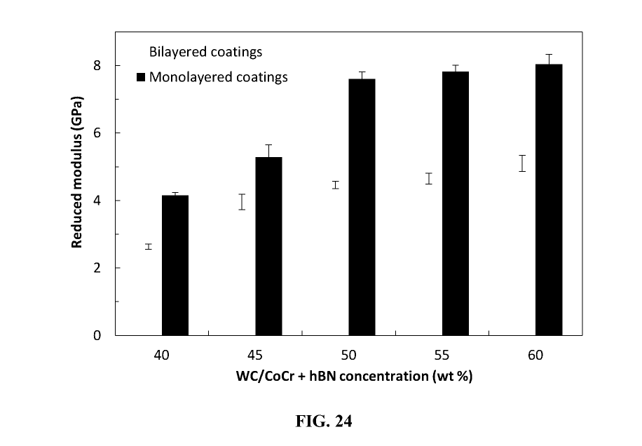

The hardness and modulus of the monolayer and bilayer coatings were measured under ambient conditions of temperature and humidity using quasi-static nanoindentation. FIG. 24 shows the reduced modulus of the monolayer coatings of compositions, D, E, F, G, and H (see TABLE 2), and bilayer coatings of compositions, J, K, L, M, and N (see TABLE 3). The overall compositions of coatings D, E, F, G, and H, were the same as those of J, K, L, M, and N, respectively. However, the bilayer coatings consisted of a layered distribution of the WC/CoCr and hBN fillers, with the hBN filler predominantly near the top of the coating.

### Example 17

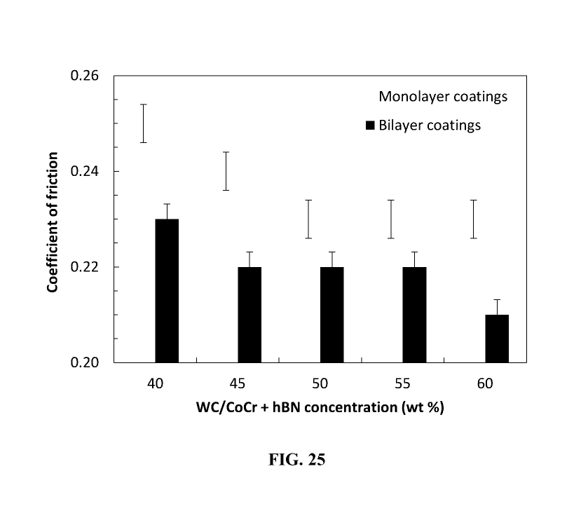

Tribological properties of the composite coatings were measured using the ball-on-flat experiments. FIG. 25 shows the coefficient of friction of the monolayer coatings of compositions, D, E, F, G, and H (see TABLE 2), and bilayer coatings of compositions, J, K, L, M, and N (see TABLE 3). The coefficient of friction decreased with an increase in the mass fraction of the ceramic in the coating. It was lower for the bilayer coating (in which the hBN particles were concentrated in the top layer of the coating) than for a monolayer coating of the same overall composition.

### Example 18

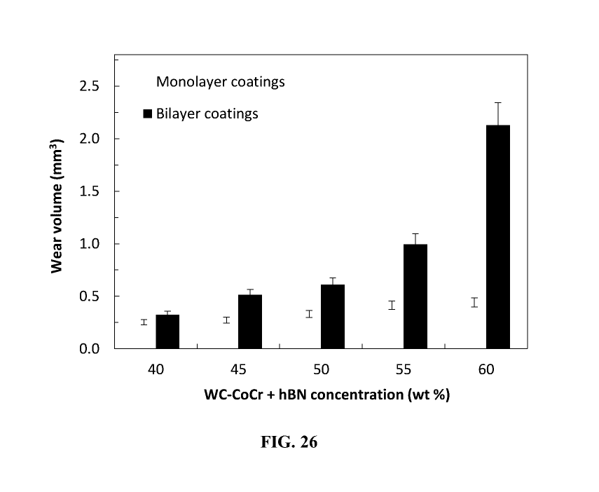

The wear volumes of the composite coatings were also measured and compared. FIG. 26 shows the wear volume of the monolayer coatings of compositions, D, E, F, G, and H (see TABLE 2), and bilayer coatings of compositions, J, K, L, M, and N (see TABLE 3). In the case of the monolayer coatings, the wear volume showed only a small increase with an increase in the filler mass fraction. The bilayer coatings, on the other hand, exhibited a large increase in wear volume with an increase in the filler concentration.

### Example 19

### Effect of Coating Deposition Technique on Porosity

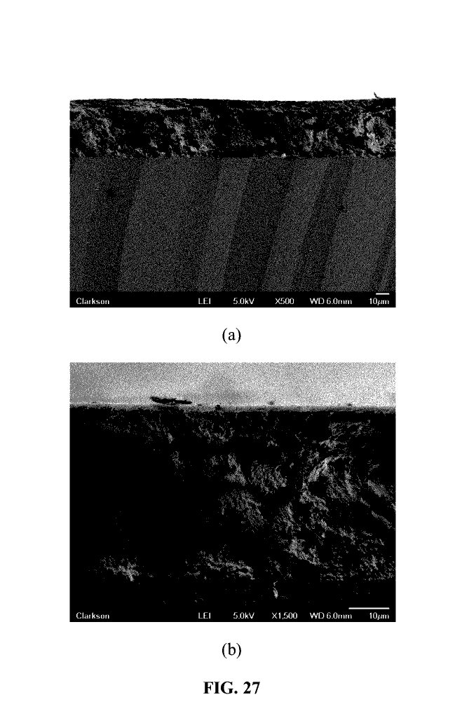

A slurry of ball-milled cubic boron nitride and PEEK in isopropanol was prepared by ball milling using the procedure given in Example 8. This slurry contained 17 vol % cBN and 83 vol % PEEK. Instead of spray coating soda-lime glass (SLG) substrates, as in Example 8, the slurry was drop deposited on the SLG substrate. After drying the solvent, a suspension of ball-milled hBN was drop deposited on top of the PEEK-cBN coating, creating a mold-release coating. The drop cast films were allowed to dry at room temperature. A second SLG glass slide was placed on top of the layered precursor film, and the sandwich assembly was heated for a period of about 50 minutes at approximately 390° C. under an applied pressure of approximately 40 MPa. Under these circumstances, the PEEK polymer acted as a common binder for both the PEEK-cBN bottom layer and the hBN surface layer, resulting in the formation of a bilayer film. A layer of hBN remained at the surface, and functioned as a mold-release layer, allowing the removal of the SLG superstrate. FIG. 27 shows SEM images of the coating obtained using this procedure. The thickness of the top hBN layer was found to be about 1.8 μm, the thickness of the middle layer (comprising of PEEK and hBN) is about 6 μm, and the thickness of the base layer (comprising of PEEK and cBN layer) is approximately 35 μm. Although the top and middle layers appear to be quite dense, the base layer appears to retain pores following the heat treatment.

What is claimed is:

1. A bilayer coating comprising:
a bottom layer comprising a first thermoplastic polymer and particles of a first ceramic or particles of a first cermet or both;
a top layer comprising a second thermoplastic polymer and particles of a second ceramic or particles of a second cermet or both.

2. The bilayer coating layer of claim 1, wherein the particles of the first and second cermet and the particles of the first and second ceramic have a mean equivalent diameter of 0.2 to 100 microns.

3. The bilayer coating layer of claim 1, wherein the first and second thermoplastic polymers are selected from a group consisting of poly(ether ether ketone) (PEEK), poly(ether ketone) (PEK), poly(ether ketone ether ketone ketone) (PEKKEK), poly(amide imide) (PAI), polyarylsulfone, and poly(ether imide) (PEI).

4. The bilayer coating layer of claim 1, wherein the particles or the first ceramic or the particles of the second ceramic are selected from the group consisting of aluminum oxide, tungsten carbide, molybdenum disulfide, and boron nitride.

5. The bilayer coating layer of claim 1, wherein the particles or the first cermet or the particles of the second cermet are selected from a group consisting of tungsten carbide/cobalt (WC/Co), tungsten carbide/cobalt-chromium (WC/CoCr), chromium carbide/nickel-chromium (CrC/NiCr), and tungsten-chromium carbide/nickel-chromium.

6. The bilayer coating layer of claim 1, wherein the first and second thermoplastic polymers form about 25% to 95% of the composition by weight; and combination of the first and second cermet particles form about 5% to 75% of the composition by weight.

7. The bilayer coating of claim 1, wherein the first thermoplastic polymer comprises PEEK and the particles of the first cermet comprise tungsten carbide/cobalt-chromium (WC/CoCr).

8. The bilayer coating of claim 1, wherein the second thermoplastic polymer comprises PEEK and the particles of the second ceramic comprises hexagonal boron nitride.

9. An article comprising a bilayer coating according to claim 1.

10. The article of claim 9, wherein the article is a gate valve.

11. A method of manufacturing a bilayer coating, the method comprising:
milling a first composition comprising a first thermoplastic polymer and particles of a first ceramic or particles of a first cermet or both to produce a first powder coating composition;
milling a second composition comprising a second thermoplastic polymer, particles of a second ceramic or particles of a second cermet or both to produce a second powder coating composition;
applying the first powder coating composition to a substrate to form a bottom layer; and
applying the second powder coating composition on top of the first powder coating composition to form a top layer.

12. The method of claim 11, wherein the first and second thermoplastic polymers are selected from a group consisting of poly(ether ether ketone) (PEEK), poly(ether ketone) (PEK), poly(ether ketone ether ketone ketone) (PEKKEK), poly(amide imide) (PAI), polyarylsulfone, and poly(ether imide) (PEI).

13. The method of claim 11, wherein the first or second milling is performed using ball milling or cryo-milling.

14. The method of claim 11, wherein the first powder coating composition or the second powder coating composition are applied by either thermal spraying or compression molding.

15. The method of claim 11, wherein the first and second thermoplastic polymers form about 25% to 95% of the composition by weight; and combination of the ceramic particles and cermet particles form about 5% to 75% of the composition by weight.

16. The method of claim 11, wherein either the first and second thermoplastic polymers have a glass transition temperature greater than about 175° C.

17. The method of claim 11, wherein the thickness of the bottom layer or the thickness of the top layer is in the range of 2 to 500 microns.

18. The method of claim 13, wherein the first powder coating composition or the second powder coating composition comprise cermet or ceramic particles with at least one particle with an equivalent particle diameter below 10 μm.

19. The method according to claim 11, further comprising the step of polishing the top layer to reduce a coefficient of friction of the top layer.

20. The method according to claim 19, wherein the coefficient of friction of the top layer after the polishing step is about 0.15.

21. A powder composition comprising
a thermoplastic polymer, wherein the thermoplastic polymer has a glass transition temperature of at least about 175° C.; and
at least one ceramic or at least one cermet,
wherein the powder composition is formed by milling the thermoplastic polymer and the at least one ceramic or at least one cermet together.

22. The composition according to claim 21, wherein the thermoplastic polymer is selected from the group consisting of poly(ether ether ketone) (PEEK), poly(ether ketone) (PEK), poly(ether ketone ether ketone ketone) (PEKKEK), poly(amide imide) (PAI), polyarylsulfone, and poly(ether imide) (PEI).

23. The composition according to claim 21, wherein the at least one ceramic is selected from the group consisting of aluminum oxide, tungsten carbide, molybdenum disulfide, and boron nitride.

24. The composition according to claim 21, wherein the at least one cermet is selected from the group consisting of tungsten carbide/cobalt (WC/Co), tungsten carbide/cobalt-chromium (WC/CoCr), chromium carbide/nickel-chromium (CrC/NiCr), and tungsten-chromium carbide/nickel-chromium.

25. An article formed by compression molding the composition according to claim 21.

26. A coating layer comprising the composition according to claim 21.
